(19) United States
(12) Patent Application Publication
(10) Pub. No.: US 2014/0369034 A1
(43) Pub. Date: Dec. 18, 2014

(54) LIGHT-EMITTING DIODE (LED) LAMP FOR EMITTING LIGHT IN NEARLY ALL DIRECTIONS

(71) Applicant: SUZHOU JINGPIN OPTOELECTRONIC CO., LTD., Wujiang, Suzhou, Jiangsu (CN)

(72) Inventor: Ju Gao, Naperville, IL (US)

(73) Assignee: Suzhou Jingpin Optoelectronic Co., Ltd., Wujiang, Suzhou, Jiangsu (CN)

(21) Appl. No.: 14/373,975

(22) PCT Filed: Oct. 16, 2012
(86) PCT No.: PCT/CN2012/083021

§ 371 Date: Jul. 23, 2014

(30) Foreign Application Priority Data
Sep. 24, 2012 (CN) 201210356824.3
Sep. 24, 2012 (CN) 201210358964.4

(51) Int. Cl. F21K 99/00; F21V 29/00; F21V 1/00; F21V 25/12

(52) U.S. Cl. CPC F21K 9/30; F21V 25/12; F21V 29/004; F21V 1/00; F21Y 2101/02
USPC 362/190

(57) ABSTRACT

A light-emitting diode lamp for emitting light in nearly all directions has a lamp holder, an LED power supply, a cylindrical surface-mounted device (SMD) LED light source, a lamp shade, a metal connecting piece, a metal radiator and a flame-retardant plastic connecting piece. The LED light source is fixed in the flame-retardant plastic connecting piece; an upper portion of the flame-retardant plastic connecting piece is mechanically fixed with the lamp holder and a lower portion is mechanically fixed with the lamp shade through the metal radiator; one end of the metal connecting piece is fixed with the metal radiator and the other end is extended into the lamp shade; the cylindrical SMD LED light source is adhered to an outer side surface of a portion of the metal connecting piece extended into the lamp shade; and the lamp holder.

### FIELD OF THE INVENTION

The present invention relates to an LED lighting fixture, in particular to an SMD LED light source for emitting light in nearly all directions and an entire LED lamp with the structure.

### BACKGROUND OF THE INVENTION

As an LED is a high-efficiency cold light emitting element capable of converting electrical energy into optical energy and has the advantages of low power consumption, long service life and the like, the use of LED lamps for lighting in the lighting field has become a trend.

The service life of an LED lamp wick is closely related to the operating temperature of a PN junction. At present, in the operating process of the LED lamp, only about 50 percent of electrical energy is converted into optical energy and the remaining electrical energy is almost converted into thermal energy, and hence the temperature of the LED lamp will be raised. When the temperature is raised for 10° C., the reliability of the LED lamp will be reduced by half. Heat dissipation is a big problem especially in high-power LED lamps. Poor heat dissipation will directly result in rapid aging of the LED lamp wick and reduced stability. Moreover, poor heat dissipation will result in serious light decay, and hence the service life of the lamp will be affected.

As packaged SMD LED emit light in a fixed direction, the emission means of the LED lamp is different from the all-dimensional emission means of the traditional light source. The LED lamp is inappropriate in many applications and the use objective of the light source can only be achieved by light distribution or secondary optical means.

### SUMMARY OF THE INVENTION

The objective of the present invention: to overcome the defects in the prior art and provide a surface-mounted device (SMD) LED light source for emitting light in nearly all directions, which has good heat dissipation and wide application range.

Technical proposal: in order to achieve the objective, the present invention adopts the technical proposal that:

The present invention relates to an LED lamp for emitting light in nearly all directions, which comprises a lamp holder, an LED power supply, a cylindrical SMD LED light source, a lamp shade , a metal connecting piece, a metal radiator and a flame-retardant plastic connecting piece, wherein the LED light source is fixed in the flame-retardant plastic connecting piece; an upper portion of the flame-retardant plastic connecting piece is mechanically fixed with the lamp holder and a lower portion is mechanically fixed with the lamp shade through the metal radiator; one end of the metal connecting piece is fixed with the metal radiator and the other end is extended into the lamp shade; the cylindrical SMD LED light source is adhered to an outer side surface of a portion of the metal connecting piece extended into the lamp shade; and the lamp holder, the LED power supply and the cylindrical SMD LED light source are in circuit connection.

In the LED lamp with the above structure, the cylindrical SMD LED light source is adhered to the periphery of the metal connecting piece to form a three-dimensional light source. The light source breaks through the traditional SMD LED light source and converts from the 180 degree emission of the traditional LED lamp to the emission at the luminous angle of more than 300 degrees. Therefore, the LED lamp has good luminous effect which is close to that of the traditional incandescent lamp, and hence is an ideal substitute of the commercially available incandescent lamp. Due to good thermal conductivity of metal, the heat generated during the operation of the cylindrical SMD LED light source can be rapidly conducted to the metal connecting piece and the metal radiator and dissipated by the metal connecting piece and the metal radiator, and hence the heat dissipation effect can be greatly improved. Moreover, the use of the flame-retardant plastic connecting piece effectively avoids the contact between the LED power supply and the metal parts and avoids the failure of products. Meanwhile, for the convenient heat dissipation of the LED power supply, a through-hole structure may also be formed on a side wall of the flame-retardant plastic connecting piece. The shape of the lamp shade may adopt the same shape of a lamp shade of the traditional incandescent lamp.

Preferably, the cylindrical SMD LED light source includes a rectangular flexible circuit board and a round circuit board; a printed circuit is arranged on both the rectangular flexible circuit board and the round circuit board; an LED bonding region is formed on the printed circuit; SMD LEDs are arranged on the LED bonding region; the rectangular flexible circuit board is curved inwards and fixed into a cylindrical shape; and the round circuit board is fixed on a bottom end surface of the cylindrical shape.

In the above structure, due to the use of the flexible circuit board, the rectangular flexible circuit board can be easily curved into required shape, and the optimal cylindrical structure is adopted in the proposal; of course, the cross section may also be designed into other regular or irregular star, polygon, ellipse and the like; if the cross section is designed to be a non-cylindrical shape, the shape of the other circuit board must be reselected and adopt adapted regular or irregular star, polygon, ellipse and the like; no matter the cross section adopts which shape, the luminous effect is same; and in view of the processing difficulty and the production cost, the cylindrical design is adopted in the proposal. The luminous angle of each SMD LED is 90 to 145 degrees. Moreover, the cylindrical shape and a light-emitting space on the bottom end surface cover each other to form nearly all-dimensional emission.

Preferably, a central portion of the cylindrical circuit board may be provided with a through hole. Due to the design of the through hole, heat in a cavity coated by the rectangular flexible circuit board and the round circuit board can be released from the through hole. Therefore, the heat dissipation potential of the entire light source can be improved and the service life of the light source can be prolonged.

Preferably, after the rectangular flexible circuit board is curved inwards, connected sides are fixed by welding, sewing or clamps; and connected sides between the round circuit board and the rectangular flexible circuit board are fixed by welding, sewing, screws, rivets or clamps. No matter which means is adopted, effective circuit connection of the printed circuits must be guaranteed. In general, all the printed circuits will be designed into an integral structure. In this case, all the LED bonding regions can be guaranteed to receive power by being electrified once. The LED bonding regions are in series or parallel connection through the arrangement of the printed circuits.

Preferably, the LED bonding regions are in series or parallel connection through the arrangement of the printed circuits.

Preferably, the rectangular flexible circuit board is adhered to a side surface of the metal connecting piece; and the round flexible circuit board is adhered to a bottom surface of the metal connecting piece.

Preferably, the rectangular flexible circuit board and the round circuit board are adhered to outer side surfaces of the metal connecting piece by heat-conductive adhesive materials.

Preferably, the SMD LED are fixed on the LED bonding regions by reflow soldering, laser welding, eutectic soldering or electrical heating. Preferably, the means of point gum or gum printing and reflow soldering is adopted. The welding process of this means will not easily damage various performances of the SMD LED.

Preferably, the LEDs are SMD LEDs.

Preferably, the metal radiating element may adopt the following structure: the metal radiator includes an annular ring member and a plurality of side rods; the side rods are uniformly arranged on the outside of the annular ring member; waist portions of the side rods are fixed with an outer side surface of the annular ring member; there are gaps among the side rods; the flame-retardant plastic connecting piece is disposed above the annular ring member; the lamp shade is disposed below the annular ring member; one end of the metal connecting piece is fixed in a hole in the middle of the annular ring member and the other end is extended into the lamp shade; portions below the waist portions of the side rods are fixed with the lamp shade; and portions above the waist portions are fixed with the flame-retardant plastic connecting piece. The portions below the waist portions and the portions above the waist portions may be specifically designed according to the shape of the lamp shade and the flame-retardant plastic connecting piece connected therewith. The fixing means may adopt a threaded structure or a clamped structure, preferably achieving convenient connection and smooth transition. Meanwhile, due to the design of the gaps among the side rods, effective heat dissipation can be achieved and the substantial results generated by high temperature during the operation of the entire product can be avoided.

Preferably, the metal connecting piece may be a solid rod or a tubular structure. By adoption of the metal connecting piece, the heat can be rapidly conducted and the heat dissipation potential can be improved.

Preferably, the metal radiator and the metal connecting piece may be made of aluminum, copper or other metal materials. Most preferably, aluminum is adopted due to good heat dissipation effect and low cost.

Preferably, surfaces of the metal radiator and the metal connecting piece may be subjected to anodizing and coating or provided with slotted holes, so as to improve the heat dissipation effect of the metal connecting piece.

Preferably, the flame-retardant plastic connecting piece is made of flame-retardant polycarbonate (PC) materials or flame-retardant heat-conductive PC materials, so as to avoid breakdown under high pressure of the LED power supply assembly and improve the safety of the overall product.

Preferably, there is a gap between an upper end of the cylindrical SMD LED light source and an opening portion of the lamp shade; and a lower end of the cylindrical SMD LED light source is level to the bottom of the metal connecting piece. Therefore, there is a heat dissipation space between the LED power supply assembly and the cylindrical SMD LED light source, and meanwhile the metal connecting piece will not shield the luminous angle of the cylindrical SMD LED light source.

Preferably, the lamp shade and the metal radiator are fixedly connected by colloids, threads, lock catches, spring pressure and the like

Preferably, the lamp shade is made of transparent or light-transmitting glass, plastics or resin materials.

Preferably, a surface of the lamp shade is subjected to atomization or multi-reflecting-surface treatment. The shape of the LED lamp may be similar to that of the traditional bulb, energy-saving lamp or other available light source.

Preferably, the lamp holder is a standard lamp holder, e.g., E26, E27 and E14, which is conducive to the replacement of the traditional lamp shade.

The advantages: the LED lamp for emitting light in nearly all directions provided by the present invention improves the heat dissipation potential of the whole LED lamp and improves the concept of small luminous angle of the traditional LED bulbs by the improvement of the structure; and meanwhile the overall luminous effect of the lamp shade is approximately close to that of the traditional incandescent lamp, so the LED lamp is an ideal substitute of the commercially available incandescent lamp and energy-saving lamp.

### BRIEF DESCRIPTION OF THE DRAWINGS

FIG. 1 is a schematic structural view of the present invention;

FIG. 2 is a schematic structural view of a flame-retardant plastic connecting piece;

FIG. 3 is a schematic structural view of a metal radiator;

FIG. 4 is a schematic structural view of a metal connecting piece;

FIG. 5 is a schematic structural view of a cylindrical SMD LED light source; and

FIG. 6 is a schematic structural expanded view of the cylindrical SMD LED light source.

### DETAILED DESCRIPTION OF THE PREFERRED EMBODIMENTS

Further description will be given below to the present invention with reference to the accompanying drawings.

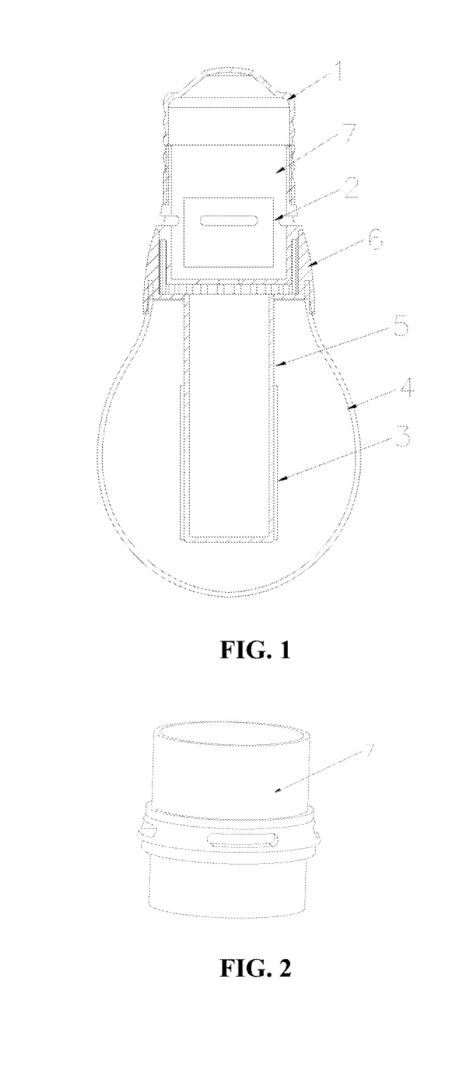

As illustrated in FIG. 1, an LED lamp for emitting light in nearly all directions comprises a lamp holder 1, an LED power supply 2, a cylindrical SMD LED light source 3, a lamp shade 4, a metal connecting piece 5, a metal radiator 6 and a flame-retardant plastic connecting piece 7. The lamp shade 4 is made of transparent or light-transmitting materials. The lamp holder 1 is a standard lamp holder.

As illustrated in FIG. 2, a side surface of the flame-retardant plastic connecting piece 7 is provided with a through hole for the convenience of heat dissipation. The flame-retardant plastic connecting piece 7 is made of flame-retardant PC materials or flame-retardant heat-conductive PC materials.

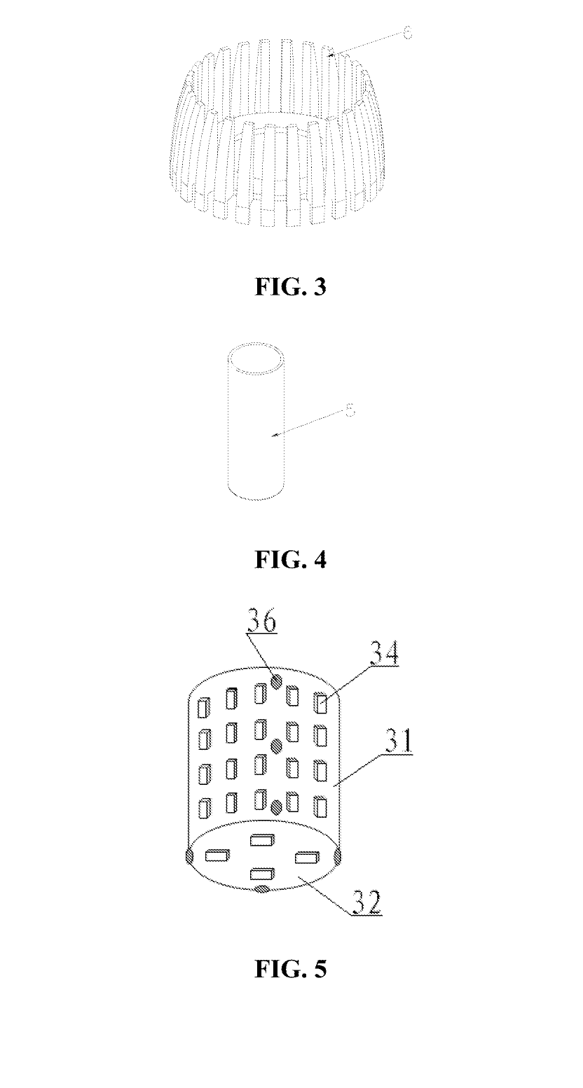

As illustrated in FIG. 3, the metal radiator 6 includes an annular ring member and a plurality of side rods; the side rods are uniformly arranged on the outside of the annular ring member; waist portions of the side rods are fixed with an outer side surface of the annular ring member; there are gaps among the side rods; the metal radiator 6 is made of aluminum; and a surface of the metal radiator 6 is subjected to anodizing and coating or provided with slotted holes.

As illustrated in FIG. 4, the metal connecting piece 5 is a tubular structure and is made of aluminum, and a surface of the metal connecting piece 5 is subjected to anodizing and coating or provided with slotted holes

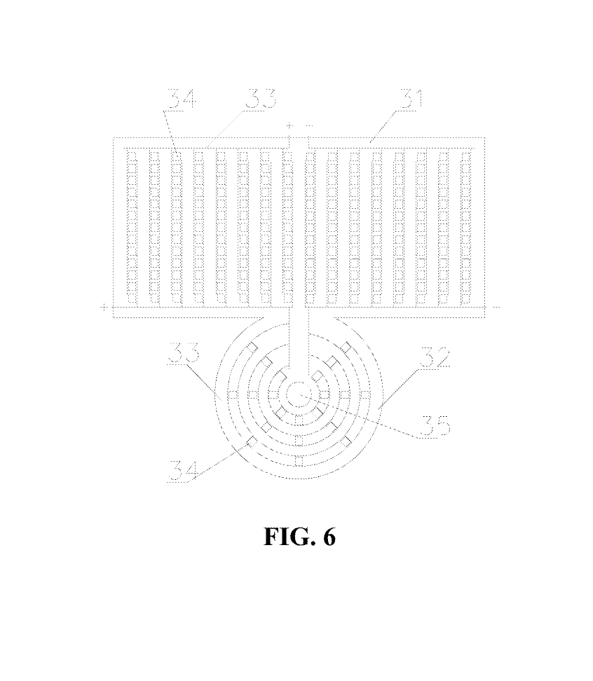

As illustrated in FIGS. 5 and 6, the cylindrical SMD LED light source 3 includes a rectangular flexible circuit board 31 and a round circuit board 32; a central portion of the round circuit board 32 is provided with a through hole 35; a printed circuit 33 is arranged on both the rectangular flexible circuit board 31 and the round circuit board 32; an LED bonding region is formed on the printed circuit 33; SMD LED or LED chips 34 are arranged on the LED bonding region; after the rectangular flexible circuit board 31 is curved inwards, connected sides are welded and fixed by bonding pads 36 to form a cylindrical shape; the round circuit board 32 is fixed on a bottom side surface of the cylindrical shape; and connected sides between the round circuit board 32 and the rectangular flexible circuit board 31 are welded and fixed by bonding pads 36.

The LED power supply 2 is fixed in the flame-retardant plastic connecting piece 7 which is disposed above the annular ring member; an upper portion of the flame-retardant plastic connecting piece 7 is mechanically fixed with the lamp holder 1 and a lower portion is fixed with portions above the waist portions of the side rods; portions below the waist portions of the side rods are fixed with the lamp shade 4; one end of the metal connecting piece 5 is fixed in a hole in the middle of the annular ring member and the other end is extended into the lamp shade 4; the cylindrical SMD LED light source 3 is adhered to a side surface of a portion of the metal connecting piece 5 extended into the lamp shade 4; there is a gap between an upper end of the cylindrical SMD LED light source 3 and an opening portion of the lamp shade 4; a lower end of the cylindrical SMD LED light source 3 is level to the bottom of the metal connecting piece 5; the metal connecting piece 5 and the metal radiator 6 do not make contact with the LED power supply assembly 2; and the lamp holder 1, the LED power supply 2 and the cylindrical SMD LED light source 3 are in circuit connection.

The foregoing is only the preferred embodiments of the present invention. It should be noted that various improvements and modifications may be also made by those skilled in the art without departing from the principle of the present invention and should also fall within the scope of protection of the present invention.

What is claimed is:

1. A light-emitting diode (LED) lamp for emitting light in nearly all directions, comprising a lamp holder (1), an LED power supply (2), a cylindrical surface-mounted device (SMD) LED light source (3), a lamp shade (4), a metal connecting piece (5), a metal radiator (6) and a flame-retardant plastic connecting piece (7), wherein the LED power supply (2) is fixed in the flame-retardant plastic connecting piece (7); an upper portion of the flame-retardant plastic connecting piece (7) is mechanically fixed with the lamp holder (1) and a lower portion is mechanically fixed with the lamp shade (4) through the metal radiator (6); one end of the metal connecting piece (5) is fixed with the metal radiator (6) and the other end is extended into the lamp shade (4); the cylindrical SMD LED light source (3) is adhered to an outer side surface of a portion of the metal connecting piece (5) extended into the lamp shade (4); and the lamp holder (1), the LED power supply (2) and the cylindrical SMD LED light source (3) are in circuit connection.

2. The LED lamp for emitting light in nearly all directions according to claim 1, wherein the cylindrical SMD LED light source (3) includes a rectangular flexible circuit board (31) and a round circuit board (32); a printed circuit (33) is arranged on both the rectangular flexible circuit board (31) and the round circuit board (32); an LED bonding region is disposed on the printed circuit (33); SMD LED (34) are arranged on the LED bonding region; the rectangular flexible circuit board (31) is curved inwards and fixed into a cylindrical shape; and the round circuit board (32) is fixed on a bottom end surface of the cylindrical shape.

3. The LED lamp for emitting light in nearly all directions according to claim 2, wherein a central portion of the round circuit board (32) may be provided with a through hole (35).

4. The LED lamp for emitting light in nearly all directions according to claim 2, wherein after the rectangular flexible circuit board (31) is curved inwards, connected sides are fixed by welding, sewing or clamps; and connected sides between the round circuit board (32) and the rectangular flexible circuit board (31) are fixed by welding, sewing, screws, rivets or clamps.

5. The LED lamp for emitting light in nearly all directions according to claim 2, wherein the LED bonding regions are in series or parallel connection through the arrangement of the printed circuits (33).

6. The LED lamp for emitting light in nearly all directions according to claim 2, wherein the rectangular flexible circuit board (31) is adhered to a side surface of the metal connecting piece (5); and the round flexible circuit board (32) is adhered to a bottom surface of the metal connecting piece (5).

7. The LED lamp for emitting light in nearly all directions according to claim 2, wherein the rectangular flexible circuit board (31) and the round circuit board (32) are adhered to outer side surfaces of the metal connecting piece (5) by heat-conductive adhesive materials.

8. The LED lamp for emitting light in nearly all directions according to claim 2, wherein the SMD LED (34) are fixed on the LED bonding regions by reflow soldering, laser welding, eutectic soldering or electrical heating.

9. The LED lamp for emitting light in nearly all directions according to claim 8, wherein the lamp beads (34) are SMD lamp beads.

10. The LED lamp for emitting light in nearly all directions according to claim 1, wherein the metal radiator (6) includes an annular ring member and a plurality of side rods; the side rods are uniformly arranged on the outside of the annular ring member; waist portions of the side rods are fixed with an outer side surface of the annular ring member; there are gaps among the side rods; the flame-retardant plastic connecting piece (7) is disposed above the annular ring member; the lamp shade (4) is disposed below the annular ring member; one end of the metal connecting piece (5) is fixed in a hole in the middle of the annular ring member and the other end is extended into the lamp shade (4); portions below the waist portions of the side rods are fixed with the lamp shade (4); and portions above the waist portions are fixed with the flame-retardant plastic connecting piece (7).

11. The LED lamp for emitting light in nearly all directions according to claim 1, wherein the metal connecting piece (5) is a solid rod or a tubular structure.

12. The LED lamp for emitting light in nearly all directions according to claim 1, wherein the metal radiator (6) and the metal connecting piece (5) are made of aluminum or copper.

13. The LED lamp for emitting light in nearly all directions according to claim 1, wherein surfaces of the metal radiator (6) and the metal connecting piece (5) are subjected to anodizing and coating or provided with slotted holes.

14. The LED lamp for emitting light in nearly all directions according to claim 1, wherein the flame-retardant plastic connecting piece (7) is made of flame-retardant polycarbonate (PC) materials or flame-retardant heat-conductive PC materials.

15. The LED lamp for emitting light in nearly all directions according to claim 1, wherein there is a gap between an upper end of the cylindrical SMD LED light source (6) and an opening portion of the lamp shade (4); and a lower end of the cylindrical SMD LED light source (6) is level to the bottom of the metal connecting piece (5).

16. The LED lamp for emitting light in nearly all directions according to claim 1, wherein the lamp shade (4) and the metal radiator (6) are fixedly connected by colloids, threads, lock catches, spring pressure and the like.

17. The LED lamp for emitting light in nearly all directions according to claim 1, wherein the lamp shade (4) is made of transparent or light-transmitting glass, plastics or resin materials.

18. The LED lamp for emitting light in nearly all directions according to claim 1, wherein a surface of the lamp shade (4) is subjected to atomization or multi-reflecting-surface treatment.

19. The LED lamp for emitting light in nearly all directions according to claim 1, wherein the lamp holder (1) is a standard lamp holder.
